(19) United States
(12) Patent Application Publication
(10) Pub. No.: US 2026/0321257 A1
(43) Pub. Date: Oct. 15, 2026

(54) INFORMATION PROCESSING DEVICE

(71) Applicant: TOYOTA JIDOSHA KABUSHIKI KAISHA, Toyota-shi (JP)

(72) Inventors: Takayuki YAMABE, Tokyo (JP); Aya YAMADA KAMISAKA, Tokyo (JP); Hajime TOJIKI, Tokyo (JP); Kota HOSHIBA, Tokyo (JP); Ryota NAKANISHI, Tokyo (JP)

(73) Assignee: TOYOTA JIDOSHA KABUSHIKI KAISHA, Toyota-shi (JP)

(21) Appl. No.: 19/537,862

(22) Filed: Feb. 12, 2026

(30) Foreign Application Priority Data
Apr. 9, 2025 (JP) 2025-064526

(51) Int. Cl. G10L 15/22; B60K 35/28; B60K 35/29

(52) U.S. Cl. CPC G10L 15/22; B60K 35/28; B60K 35/29

(57) ABSTRACT

First data for estimating the content of knowledge each of a plurality of users has is stored. A conversation conducted among the users is acquired, and first information that is information related to the conversation is acquired. Whether at least one of the users has knowledge regarding the first information is estimated based on the first data, and whether to output the first information is determined based at least on the result of the estimation.

### CROSS-REFERENCE TO RELATED APPLICATION

This application claims priority to Japanese Patent Application No. 2025-064526 filed on Apr. 9, 2025. The disclosure of the above-identified application, including the specification, drawings, and claims, is incorporated by reference herein in its entirety.

### BACKGROUND

### 1. Technical Field

The present disclosure relates to dialogue technology using machine learning models.

### 2. Description of Related Art

Systems have been provided that enable voice-based dialogue in vehicles. In this regard, for example, WO 2021/200307 discloses a conversational system in which an AI agent actively participates in a conversation being held among multiple people.

### SUMMARY

With future advances in machine learning, services that enable dialogue in natural language are expected to become increasingly widespread.

An object of the present disclosure is to provide appropriate information in a voice-based dialogue system.

One aspect of an embodiment of the present disclosure is an information processing device including: a storage unit that stores first data for estimating the content of knowledge each of a plurality of users has; and a control unit configured to acquire a conversation conducted among the users, acquire first information that is information related to the conversation, make, based on the first data, an estimation of whether at least one of the users has knowledge regarding the first information, and determine, based at least on a result of the estimation, whether to output the first information.

Other aspects include a method executed by the above information processing device, a program that causes a computer to execute the method, and a computer-readable storage medium that stores the program in a non-transitory manner.

With the present disclosure, it is possible to provide appropriate information in a voice-based dialogue system.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a dialogue system according to a first embodiment;

FIG. 2 is a configuration diagram of an in-vehicle device according to the first embodiment;

FIG. 3A illustrates an example of a feature database;

FIG. 3B illustrates an example of a knowledge database;

FIG. 4 illustrates a flow of processing executed by a control unit of the in-vehicle device;

FIG. 5 is a flowchart of processing executed by the control unit of the in-vehicle device; and

FIG. 6 is a second flowchart of processing executed by the control unit of the in-vehicle device.

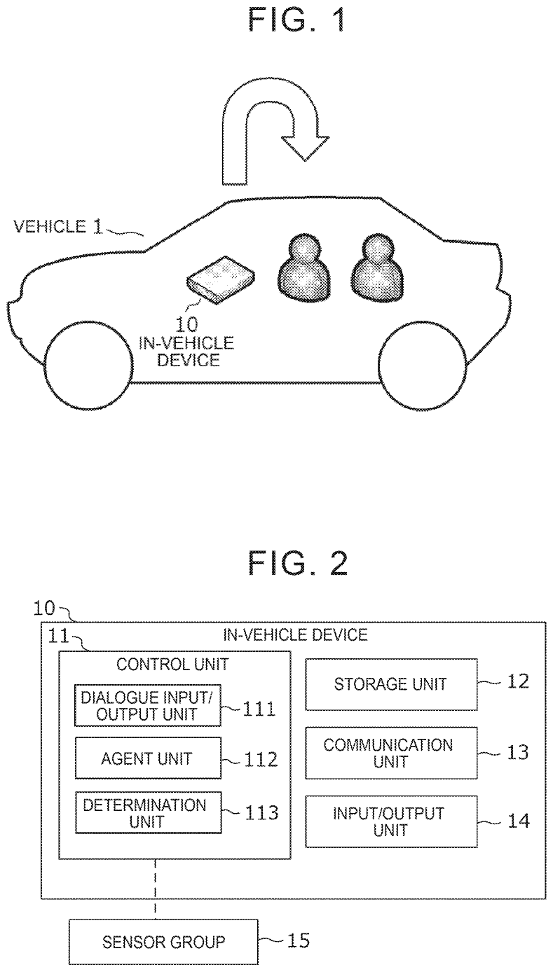

### DETAILED DESCRIPTION OF EMBODIMENTS

In recent years, advances in machine learning have increased the number of products equipped with language models. For example, a natural-language dialogue function can be added to a target product by incorporating into the product a large language model (LLM) whose accuracy has been improved through machine learning using a large-scale dataset.

An automobile is one example in which dialogue in natural language is useful. For example, by equipping an in-vehicle device with an LLM, it becomes possible to obtain information without operating a touch panel or the like. Such a function is particularly useful when the hands of the user are occupied, such as while driving.

An LLM can not only output responses to questions, but can also participate in conversations being held among occupants and actively provide related information. For example, when the occupants in the vehicle are discussing a future destination, the device can search for candidate locations in the background and actively provides the results.

However, when an in-vehicle device is caused to perform such operations, it may provide information that an occupant already knows. For example, in a case where occupants are talking inside the vehicle about visiting a particular facility. the device may actively propose route guidance to the facility. However, if the driver is already familiar with the facility, the device may end up providing unnecessary information, which may annoy the driver.

An information processing device according to a first aspect of the present disclosure includes:
a storage unit that stores first data for estimating the content of knowledge each of a plurality of users has; and a control unit configured to acquire a conversation conducted among the users, acquire first information that is information related to the conversation, make, based on the first data, an estimation of whether at least one of the users has knowledge regarding the first information, and determine, based at least on a result of the estimation, whether to output the first information.

The information processing device may be, for example, a device mounted in a vehicle (an in-vehicle device). For example, the information processing device can acquire information related to a conversation conducted inside the vehicle (the first information) based on the content of that conversation, and actively output the information. The first information may be, for example, additional information related to the facility being discussed in the conversation (for example, route information, business information, etc.).

The control unit estimates, based on the first data for estimating the content of the knowledge each of the users has, whether at least one of the users has, as knowledge, the information that is to be output. The control unit then determines whether to output the first information, based at least on the result of the estimation.

For example, when it is estimated that at least one of the users has knowledge regarding the information to be output, the control unit may suppress output of the first information.

The first data may be, for example, past behavioral histories of the users. By referring to the past behavioral histories, determinations such as the following can be made: “Since a user who has previously visited a particular facility and is considered to have knowledge regarding that facility is riding in the vehicle, there is no need to output additional information related to that facility (the first information).”

The predetermined timing may be, for example, a timing at which the conversation among the users has paused.

The first data may be stored in the information processing device, or may be acquired from terminals respectively associated with the users. For example, when the first data is data related to past behavioral histories, the control unit may acquire the data related to the behavioral histories from mobile terminals carried by the users.

The first information may include information related to a first facility, and the control unit may be configured to estimate, based on the behavioral histories of the users, whether at least one of the users has knowledge regarding the first facility as the knowledge regarding the first information.

When the first information is information related to a facility, whether the user concerned has knowledge related to the facility can be estimated based on whether there is a history of visiting the facility.

The control unit may be configured to, when a period during which none of the users is speaking continues for at least a predetermined length of time, output the first information even when the estimation is made that at least one of the users has the knowledge regarding the first information.

Even when a certain amount of time has elapsed and no utterance related to the first information has actually been made, it is preferable for the information processing device to output the first information.

The control unit may be configured to, when a conversation conducted among the users following the conversation includes incorrect information and the incorrect information is correctable by the first information, output the first information regardless of the result of the estimation.

Thus, when an utterance that includes incorrect information is made and the incorrect information can be corrected by the first information, it is preferable for the information processing device to correct the incorrect information by outputting the first information.

Hereinafter, specific embodiments of the present disclosure will be described with reference to the drawings. Unless otherwise specified, the hardware configurations, module configurations, functional configurations, etc. described in the embodiments are not intended to limit the technical scope of the present disclosure to those configurations.

### First Embodiment

### System Overview

An overview of a dialogue system according to a first embodiment will be described. The dialogue system according to the present embodiment includes an in-vehicle device 10 mounted in a vehicle 1. The in-vehicle device 10 is a device capable of providing a dialogue service in natural language using a virtual agent.

A virtual agent is a program that can engage in dialogue in natural language and can be executed by the in-vehicle device 10. By executing a virtual agent on the in-vehicle device 10 and keeping it resident, the occupants of the vehicle can receive an information provision service in natural language at any desired timing.

The virtual agent may behave as different agents for the respective users riding in the vehicle 1 by loading different language models for each user. For example, in a case where there are four users who regularly ride in the vehicle 1, the in-vehicle device 10 may store four corresponding language models. In such a case, the in-vehicle device 10 can provide information using the language model corresponding to the user riding in the vehicle. Each language model may contain data related to that user's private information and preferences, and may be configured to provide personalized suggestions etc.

The in-vehicle device 10 is mounted in a connected vehicle that can communicate with various devices via wireless communication. The in-vehicle device 10 may include a data communication module (DCM) for connecting components of the vehicle (e.g., electronic control units (ECUs) and in-vehicle terminals) to a network. The virtual agent operating on the in-vehicle device 10 can also acquire information from external devices etc. via the network.

In the present embodiment, the virtual agent executed by the in-vehicle device 10 can not only provide information in response to requests from the occupants but also monitor conversations taking place inside the vehicle and actively provide information depending on the situation.

For example, it is herein assumed that the occupants are discussing possible destinations and one of the candidate stores is currently closed. In such a case, the virtual agent can generate and output information such as “It looks like that ○○ is closed today,” based on store information acquired in the background.

On the other hand, there are cases where the occupants already have knowledge regarding the information that the virtual agent is going to output. In such cases, the information the occupants already know is output, which may annoy the occupants.

Therefore, in the present embodiment, the in-vehicle device 10 acquires data related to the knowledge of the occupants riding in the vehicle (the “first data” in the present disclosure), and provides information when it is estimated that “none of the occupants of the vehicle have knowledge regarding the information to be output.”

### Device Configuration

Next, configurations of the devices that constitute the system will be described. FIG. 2 is a schematic diagram illustrating an example of the configuration of the vehicle 1 according to the present embodiment.

The in-vehicle device 10 can be configured as a computer that includes a processor (a central processing unit (CPU), a graphics processing unit (GPU), etc.), a main storage device (random access memory (RAM), read-only memory (ROM), etc.), and an auxiliary storage device (erasable programmable read-only memory (EPROM), hard disk drive, removable medium, etc.). The auxiliary storage device stores an operating system (OS), various programs, various tables, etc. Various functions (software modules) for predetermined purposes, as described later, can be implemented by executing the programs stored in the auxiliary storage device. However, part or all of the functions may alternatively be implemented as hardware modules by using hardware circuits such as application-specific integrated circuits (ASICs) or field-programmable gate arrays (FPGAs).

The in-vehicle device 10 includes, as hardware components, a control unit 11, a storage unit 12, a communication unit 13, and an input/output unit 14. The in-vehicle device 10 is also connected to a sensor group 15 provided in the vehicle 1.

The control unit 11 is a computing unit that implements various functions of the in-vehicle device 10 by executing predetermined programs. The control unit 11 can be implemented by, for example, a hardware processor such as a CPU. The control unit 11 may include RAM, ROM, and cache memory.

In the present embodiment, the control unit 11 of the in-vehicle device 10 includes three software modules: a dialogue input/output unit 111, an agent unit 112, and a determination unit 113. Each software module may be implemented by the control unit 11 (e.g., the CPU) executing a program stored in the storage unit 12. The information processing executed by the software modules is equivalent to the information processing executed by the control unit 11 (e.g., the CPU).

The dialogue input/output unit 111 acquires utterances made by the vehicle occupants via the input/output unit 14. The dialogue input/output unit 111 performs predetermined processing on the acquired audio data and executes speech recognition. The content of the utterance is thus converted into text. The dialogue input/output unit 111 then sends the text obtained through the speech recognition to the agent unit 112.

The dialogue input/output unit 111 also converts utterances transmitted from the agent unit 112 into audio and outputs it via the input/output unit 14.

The agent unit 112 provides a dialogue service using a language model. By providing a dialogue service using a language model, the agent unit 112 can behave as a virtual agent.

The virtual agent may be implemented, for example, by a combination of a program and a language model. In the present embodiment, different language models are used for each occupant. For example, the agent unit 112 can behave as a virtual agent for user A by using the language model corresponding to user A, and can behave as a virtual agent for user B by using the language model corresponding to user B.

In the present embodiment, these language models are stored in the storage unit 12 described later.

The agent unit 112 can set up a virtual agent by acquiring, for example, the language model corresponding to the driver from the storage unit 12.

When dialogue involves specialized knowledge, the agent unit 112 may also acquire information from one or more external devices available via a network. For example, when it is determined that the occupant who made the utterance is seeking information related to a facility or store, the agent unit 112 may access an external language model that is accessible via a network and capable of providing local information, and acquire information.

The agent unit 112 can provide information in response to a request made through an utterance, and also has a function of monitoring conversations conducted inside the vehicle, obtaining additional information, and outputting it spontaneously.

For example, the agent unit 112 estimates, based on the content of the conversation, that the vehicle occupants need information related to a particular subject (for example, information related to a facility they are considering visiting), and searches for such information in the background.
The agent unit 112 then acquires from the determination unit 113 (described later) information for identifying the occupants of the vehicle, and based on the acquired information, searches a knowledge database (described later) to estimate the knowledge that each occupant of the vehicle is estimated to have.

The knowledge database is a collection of data for estimating the knowledge that the occupants of the vehicle have.

The knowledge database may include personal information. For example, when user A has an educational background or work experience in a particular field, it can be estimated that “user A has knowledge related to that field.” Knowledge may also be estimated based on past experience. For example, when the knowledge database includes a behavioral history indicating that user A has visited a particular location in the past, it can be estimated that “user A has knowledge about that location.”
Based on the result of this estimation, the agent unit 112 determines whether to output the target information, and then outputs the information.

The determination unit 113 identifies the persons riding in the vehicle 1. For example, the determination unit 113 identifies the persons riding in the vehicle 1, based on sensor data output from a plurality of sensors included in the sensor group 15 (described later) and a feature database (described later) that stores feature values of persons, and acquires their identifiers.

For example, when user A is riding in the vehicle, the determination unit 113 acquires the identifier of user A based on biometric information, image information, etc. acquired from the sensors. The identification of persons riding in the vehicle may be performed based on biometric information, facial images, etc. acquired via sensors, or may be performed using other additional information. For example, when each occupant of the vehicle 1 carries a mobile terminal, the persons riding in the vehicle may be identified based on the result of short-range wireless communication with the mobile terminals. The identification result is sent to the agent unit 112.

The storage unit 12 is means for storing information, and is configured by a storage medium such as RAM, a magnetic disk, or flash memory. The storage unit 12 stores programs executed by the control unit 11 and data used by the programs.

The storage unit 12 also stores the feature database and the knowledge database described above.

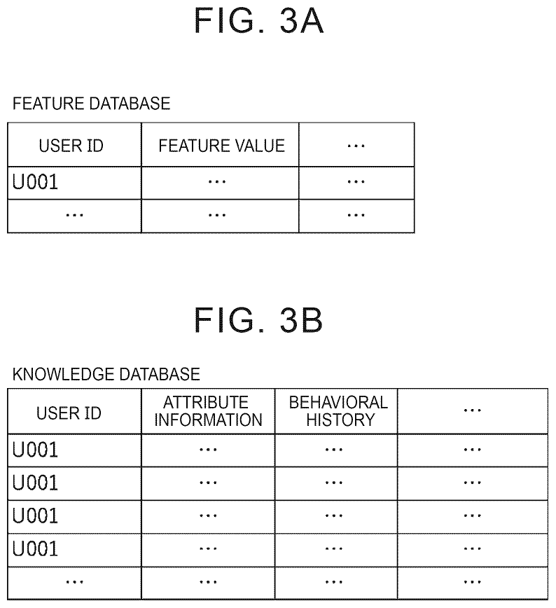

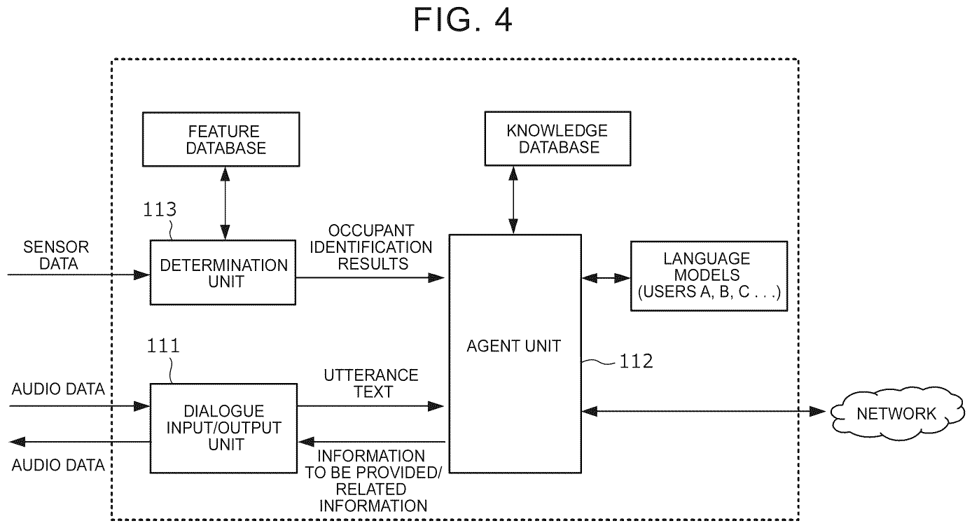

FIG. 3A illustrates an example of the feature database. In the feature database, feature values obtained from sensor data are stored in association with personal identifiers (user IDs). FIG. 3B illustrates an example of the knowledge database. In the knowledge database, personal identifiers (user IDs) are stored in association with attribute information and behavioral histories. Attribute information refers to personal information that can be used to estimate knowledge, and may be information about educational background, work experience, or specialty. A behavioral history is information indicating locations visited in the past etc. The behavior history may be a set of location information arranged in chronological order.

The communication unit 13 includes a communication module that performs wireless communication with a predetermined network (for example, a wide-area network such as the Internet). In the present embodiment, the communication unit 13 is configured to communicate with a predetermined mobile communication network. The communication unit 13 may include an embedded Universal Integrated Circuit Card (eUICC) (for example, a Subscriber Identity Module (SIM) card). The in-vehicle device 10 can communicate with external devices through the communication unit 13 via the predetermined mobile communication network.

The input/output unit 14 is a unit that receives input from a user of the device and presents information to the user. The input/output unit 14 typically includes devices that input and output audio, such as a microphone and a speaker. The input/output unit 14 may also include a device that provides visual information (for example, a display).

The sensor group 15 is a collection of multiple sensors provided in the vehicle 1. The sensors are not limited to any particular type as long as they can acquire data for identifying persons riding in the vehicle, such as image sensors and biometric sensors. Means for performing personal identification by communicating with mobile terminals present in the vehicle cabin may also be included in the sensor group 15.

The configuration shown in FIG. 2 is merely an example, and all or part of the illustrated functions may be executed using dedicated circuits. Programs may be stored or executed using any combination of main and auxiliary storage devices other than the illustrated combination.

### Processing Flow

Next, an overview of the processing executed by the control unit 11 will be described. FIG. 4 illustrates a flow of processing executed by the control unit 11 of the in-vehicle device 10.

The dialogue input/output unit 111 acquires an utterance from a vehicle occupant via the input/output unit 14. For example, the input/output unit 14 converts the utterance acquired through a microphone into audio data, and the dialogue input/output unit 111 acquires this audio data. The dialogue input/output unit 111 executes predetermined speech recognition processing on the acquired audio data and converts the audio data into text. The dialogue input/output unit 111, while withholding a response to the utterance, sends the text obtained through the speech recognition to the agent unit 112. This text will be hereinafter referred to as “utterance text.”

For example, when the content of the utterance text is a request to activate the virtual agent, the agent unit 112 activates the virtual agent in response to the utterance by using the language model corresponding to the occupant who made the utterance.

When the content of the utterance text is a request for dialogue with the virtual agent, the agent unit 112 generates a response using the acquired language model. For example, in a case where the virtual agent being executed corresponds to user A, the agent unit 112 transfers the utterance text to the language model corresponding to user A. When it is determined that the language model corresponding to user A cannot provide sufficient information, the agent unit 112 may transfer the utterance text to an external language model (remote language model) via a network. The agent unit 112 acquires, from the target language model, the response (information to be provided) generated in response to the utterance text.

The agent unit 112 can also provide information spontaneously. For example, the agent unit 112 may acquire, from the dialogue input/output unit 111, the utterance text corresponding to a conversation taking place among multiple occupants inside the vehicle, and may understand the gist or content of the conversation. In such a case, the agent unit 112 determines that it is necessary to provide additional information related to the conversation (hereinafter, “related information”) to the vehicle occupants, and acquires the related information (for example, via a language model stored in its own device or in an external device).

The processing executed by the determination unit 113 will now be described. The determination unit 113 identifies multiple persons riding in the vehicle 1 based on sensor data output from the sensors included in the sensor group 15. The identification of persons may be performed by, for example, searching the feature database using feature values obtained by converting the sensor data. The identification result is sent to the agent unit 112.

The agent unit 112 estimates, based on the identification result obtained from the determination unit 113, whether there is an occupant who has knowledge regarding the information that is to be provided.

For example, based on the identification result obtained from the determination unit 113 (for example, multiple identifiers respectively corresponding to the occupants), the agent unit 112 acquires, for each occupant, data related to knowledge from the knowledge database.

An example of data related to knowledge is “user A and user B are riding in the vehicle, user A specializes in electrical engineering, and user B is a student.” The data related to knowledge may also include data regarding the past behavioral histories of user A and user B. This is because an occupant can be estimated to have a certain level of knowledge about locations the occupant has visited.

The agent unit 112 makes an estimation about the knowledge that each occupant has, based on such data.

For example, when the closing time of a restaurant being considered for a visit in the conversation is approaching, the agent unit 112 is assumed to generate, as related information, information regarding the business hours of the restaurant. In this case, when an occupant who has visited that restaurant after business hours is participating in the conversation, that occupant is estimated to have knowledge regarding the business hours of the restaurant.

The agent unit 112 outputs the related information on the condition that there is no occupant who has knowledge regarding the related information that is to be provided.

In the present embodiment, whether the occupants of the vehicle have specific knowledge is estimated based on the information stored in the knowledge database. However, the estimation method is not limited to any particular technique. For example, the agent unit 112 may acquire, from the user's mobile terminal, information regarding messages, emails, SNS, etc. that the user has sent or received in the past, or information regarding the past behavioral history, and may estimate knowledge based on the content of the acquired information.

### Flowchart

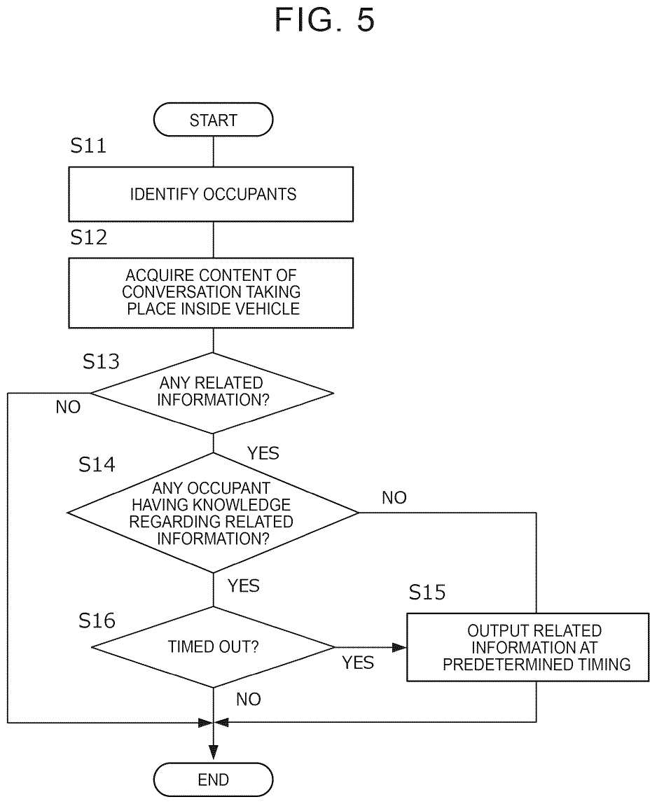

Next, the processing executed by the in-vehicle device 10 will be described in detail. FIG. 5 is a flowchart illustrating the processing executed by the in-vehicle device 10. The processing shown in FIG. 5 is periodically executed while the virtual agent is in operation.

First, in step S11, the determination unit 113 identifies the occupants of the vehicle. In this step, the determination unit 113 first acquires sensor data. The sensor data may be acquired from the sensors included in the sensor group 15. Based on feature values obtained from the sensor data, the determination unit 113 then searches the feature database and obtains the identification result (for example, personal identifiers) of the occupants. The identification result is sent to the agent unit 112.

The occupants of the vehicle may also be identified using information other than sensor data. For example, the determination unit 113 may acquire data for identifying the occupants of the vehicle by communicating with terminals carried by the occupants via a unit or module that performs short-range wireless communication.

When the identification of the individuals has been completed and no boarding or alighting of persons has occurred, step S11 may be omitted.

Next, in step S12, the agent unit 112 acquires the content of the conversation taking place inside the vehicle. The conversation may be acquired by analyzing audio data collected during a predetermined past period Therefore, the agent unit 112 may execute processing for collecting audio data in the background.

In step S13, the agent unit 112 generates related information (information related to the subject being discussed in the conversation etc.) based on the acquired content of the conversation.

Whether to generate related information may be determined in a rule-based manner or may be determined by a machine learning model. In the former case, for example, rules such as “generate related information when a visit to a facility is being discussed and there is a possibility that arrival will be outside business hours” or “generate related information when a visit to a facility is being discussed and there is no mention of usage fees in the conversation” may be used.
When related information has been generated, the processing proceeds to step S14. When related information has not been generated, the processing ends.

In step S14, the agent unit 112 estimates whether there is an occupant who has knowledge regarding the generated related information. For example, when the related information is information regarding a facility and “a person who has previously visited a facility in question is regarded as having knowledge regarding the facility,” the agent unit may determine whether a person who has a history of visiting the facility is riding in the vehicle 1. When a negative determination is made in this step, the processing proceeds to step S15. When an affirmative determination is made in this step, the processing proceeds to step S16.

When the processing proceeds to step S15, the agent unit 112 outputs related information at a predetermined timing. The predetermined timing may be, for example, a timing at which none of the occupants of the vehicle are speaking.

In a case where the processing proceeds to step S16, an occupant who has knowledge regarding the related information is riding in the vehicle 1. Therefore, the agent unit 112 basically does not output the related information. However, when no utterance including the related information has been made even after a predetermined period has elapsed, it is preferable to output the related information. Accordingly, in step S16, the agent unit 112 waits for the predetermined period to see whether an utterance including the related information is made. When the predetermined period times out, the agent unit 112 outputs the related information (step S16, Yes). When the predetermined period does not time out and an utterance including the related information is made (step S16, No), the processing ends.

In addition to the condition that “a predetermined period has elapsed,” it is also possible to set conditions for executing the output of the related information.

As described above, the in-vehicle device according to the first embodiment generates related information based on the content of conversations among multiple persons riding in the same vehicle. When it is estimated that no person having knowledge regarding the related information is riding in the vehicle, the related information is output. This configuration reduces the likelihood that unnecessary information will be provided, and makes it less likely that the occupants will be annoyed.

### Second Embodiment

In the first embodiment, when it is estimated that a person having knowledge regarding the related information is riding in the vehicle, the in-vehicle device 10 suppresses the output of the related information.

However, such a person may have incorrect knowledge. The second embodiment addresses this by performing a correction using the related information when an utterance based on incorrect knowledge is made.

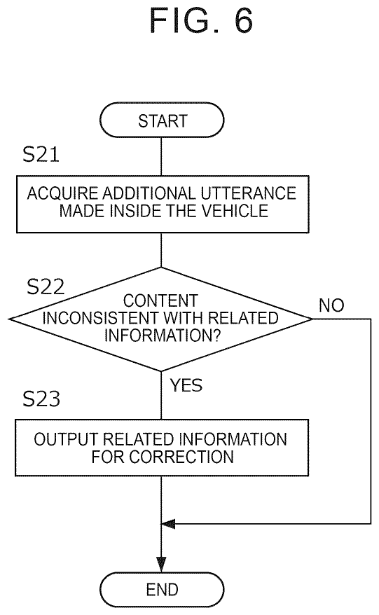

FIG. 6 is a flowchart illustrating the processing executed by the in-vehicle device 10 (the control unit 11) according to the second embodiment. The illustrated processing is started when no timeout has occurred in step S16, that is, when the occupants of the vehicle have made an utterance related to the related information.

First, in step S21, the agent unit 112 acquires an additional utterance made inside the vehicle. For example, suppose the related information is information about the closed days of a store and an utterance regarding the business days of the store is made. In step S22, the agent unit 112 determines whether the content of the utterance contains incorrect information, that is, whether the content of the utterance is inconsistent with the related information.

For example, when the related information indicates that the store to be visited is closed on Mondays, and the utterance includes the content stating that the store is open on Mondays, an affirmative determination is made in this step, and the processing proceeds to step S23. When a negative determination is made in this step, the processing ends.

In step S23, the agent unit 112 outputs the related information in order to correct the utterance. In this step, a response pointing out that the utterance is incorrect may be generated and output together with the related information, or the related information alone may be output.

In the second embodiment, when an utterance made by a vehicle occupant contains an error, the system outputs an utterance regardless of the result of the knowledge estimation. With such a configuration, correct information can be provided without causing annoyance to the occupants.

### Modifications

The above embodiments are merely examples, and the present disclosure may be modified as appropriate without departing from the spirit and scope of the present disclosure.

For example, the processes and means described in the present disclosure may be combined as desired as long as no technical contradiction occurs.

The embodiment illustrates an example in which a language model provides information. However, the source of the information provided from the in-vehicle device 10 is not limited to language models. For example, when a given program (a user application) is running on the in-vehicle device 10, filtering may be performed on information output by that user application. In such a case, the agent unit 112 may relay and filter the information concerned.

In the description of the embodiments, information is provided when it is estimated that the occupants of the vehicle do not have knowledge regarding the information to be provided. However, information may be provided when it is estimated that the occupants have knowledge regarding the information to be provided. This can promote conversation.

The processing described as being performed by a single device may be shared and performed by a plurality of devices. Alternatively, the processing described as being performed by different devices may be performed by a single device. In a computer system, the hardware configuration (server configuration) that implements each function can be changed flexibly.

The present disclosure may also be implemented by supplying a computer with a computer program that implements the functions described in the above embodiments, and causing one or more processors included in the computer to read and execute the program. Such a computer program may be provided to the computer via a non-transitory computer-readable storage medium connectable to the system bus of the computer, or may be provided to the computer via a network. Examples of the non-transitory computer-readable storage medium may include any type of disk such as a magnetic disk (floppy (registered trademark) disk, hard disk drive (HDD), etc.), an optical disc (compact disc read-only memory (CD-ROM), digital versatile disc (DVD), Blu-ray disc, etc.), read-only memory (ROM), random access memory (RAM), erasable programmable read-only memory (EPROM), electrically erasable programmable read-only memory (EEPROM), a magnetic card, flash memory, an optical card, and any other type of medium suitable for storing electronic instructions.

What is claimed is:

1. An information processing device comprising:
a storage unit that stores first data for estimating content of knowledge each of a plurality of users has; and
a control unit configured to
acquire a conversation conducted among the users,
acquire first information that is information related to the conversation,
make, based on the first data, an estimation of whether at least one of the users has knowledge regarding the first information, and
determine, based at least on a result of the estimation, whether to output the first information.

2. The information processing device according to claim 1, wherein:
the first information includes information related to a first facility; and
the control unit is configured to estimate, based on respective behavioral histories of the users, whether at least one of the users has knowledge regarding the first facility as the knowledge regarding the first information.

3. The information processing device according to claim 1, wherein the control unit is configured not to output the first information when an estimation is made that at least one of the users has the knowledge regarding the first information.

4. The information processing device according to claim 3, wherein the control unit is configured to, when a period during which none of the users is speaking continues for at least a predetermined length of time, output the first information even when the estimation is made that at least one of the users has the knowledge regarding the first information.

5. The information processing device according to claim 1, wherein the control unit is configured to, when a conversation conducted among the users following the conversation includes incorrect information and the incorrect information is correctable by the first information, output the first information regardless of the result of the estimation.
